(19) United States
(12) Patent Application Publication
(10) Pub. No.: US 2007/0142141 A1
(43) Pub. Date: Jun. 21, 2007

(54) Method and apparatus for monitoring the operational reliability of a transmission that transmits torque by frictional engagement

(75) Inventor: Martin Vornehm, Buhl (DE)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Buhl (DE)

(21) Appl. No.: 11/473,516

(22) Filed: Jun. 24, 2006

Related U.S. Application Data
(60) Provisional application No. 60/695,397, filed on Jun. 30, 2005.

(30) Foreign Application Priority Data
Jun. 25, 2005 (DE) 10 2005 029 568.1

(51) Int. Cl. F16H 59/00; F16H 61/00

(52) U.S. Cl. 474/12; 474/17

(57) ABSTRACT

A method and apparatus for monitoring the operational reliability of a transmission having a continuously variable transmission ratio that transmits torque by frictional engagement of transmission components. A damage model is provided that contains a damage value that is a function of transmission operating parameters that are applicable to an assessment of damage to the frictional contact regions that transmit torque through frictional engagement. The values of the operating parameters during transmission operation are ascertained and the damage level reached from the ascertained operating parameters is determined. A value derived from the momentary damage value is displayed. The method is carried out with monitoring apparatus that includes sensors for sensing transmission operating parameters, and an evaluation unit for determining damage values based upon sensor outputs.

### BACKGROUND OF THE INVENTION

1. Field of the Invention

The present invention relates to a method and apparatus for monitoring the operational reliability of a transmission having a continuously variable transmission ratio and that transmits torque by frictional engagement.

2. Description of the Related Art

Various types of transmissions exist having a continuously variable transmission ratio and that transmit torque by frictional engagement, for example, friction gear transmissions, friction ring transmissions, belt-driven conical-pulley transmissions etc. Those transmissions have in common that the components that transmit force or power through friction must be in mutual contact with surfaces of elements that clamped against each other, in order for frictional engagement to be possible. The surfaces of the elements that are in frictional engagement with each other are under great stress as a consequence of the clamping, and can involve possible slippage and high temperatures, which can result in damage to the friction surfaces and thereby reduce the operability of the transmission.

An object of the invention is to provide a method for monitoring the operating reliability of a transmission having a continuously variable transmission ratio and that transmits torque by frictional engagement, and which method permits an indication of operating reliability and enables a warning or countermeasures before operating reliability is impaired.

Another object of the invention is to provide apparatus for monitoring the operational reliability of a transmission having a continuously variable transmission ratio and that transmits torque by frictional engagement.

### SUMMARY OF THE INVENTION

Briefly stated, in accordance with one aspect of the present invention, a method is provided for monitoring the operational reliability of a transmission having a continuously variable transmission ratio that transmits torque by frictional engagement. The method includes providing a damage model that contains a damage value that depends upon operating parameters that are relevant for an assessment of damage to the contact areas that transmit torque by frictional engagement; ascertaining the values of the operating parameters during operation; determining a damage level reached based upon the ascertained operating parameters; and displaying a value derived from the momentary damage level value.

In accordance with the invention, a damage model is thus employed that indicates total damage to the transmission and/or damage to the individual surface elements that come into frictional engagement with each other. The damage model can be obtained from mathematical calculations, test stand trials, or combinations of the two. It is possible on the basis of the damage model to calculate a damage value reached at the moment from the operating parameters measured during operation. A predetermined damage value is specified for the transmission, or damage values that must not be exceeded are assigned to individual surface areas. The momentary damage value or values can be displayed or evaluated in their relationship to the permissible damage value or values, so that information about the damage condition of the transmission is possible in each case. Advantageously, a warning is triggered when a permissible damage value is exceeded.

Advantageously, the damage value reached at the end of an operating cycle is stored, and then forms the starting value of the damage value at the beginning of a subsequent operating cycle.

At least one of the following operating parameters can be taken into account in the damage model: temperature at the location of the frictional engagement, pressure between the frictionally engaged parts, slippage between the frictionally engaged parts, location of the frictional engagement, duration of the frictional engagement. The temperature can be measured directly and/or calculated from the pressure, the slippage, and the duration.

The method in accordance with the invention can be used for all types of transmissions that transmit torque. Advantageously, it is used for a belt-driven conical-pulley transmission.

The determination of the damage values of the individual surface areas can be used to control the transmission in such a way that frictional engagement between points of contact having high damage values is avoided.

Apparatus for monitoring the operational reliability of a transmission having a continuously variable transmission ratio that transmits torque through frictional engagement includes sensors for detecting operating parameters that are relevant for an assessment of damage to the contact areas that transmit torque by frictional engagement. An evaluation unit is connected to the sensors to determine a damage value from the ascertained values of the operating parameters on the basis of a damage model stored in it. The evaluation unit includes a storage device in which the damage value reached during an operating cycle is stored, so that the damage value is available as the starting value for a subsequent operating cycle. A display device is provided for displaying a value that is derived from a momentary damage value. The display device does not necessarily have to be visual—it can also be of such a nature that it passes the ascertained damage value or values to a transmission control device that modifies the operation of the transmission, depending upon the ascertained damage value or values.

### BRIEF DESCRIPTION OF THE DRAWINGS

The structure, operation, and advantages of the present invention will become further apparent upon consideration of the following description, taken in conjunction with the accompanying drawings in which:

FIG. 1 is a schematic diagram of a belt-driven conical-pulley transmission including a control and evaluation unit; and

FIG. 2 is a flow chart showing a sequence of method steps for a method in accordance with the invention.

### DESCRIPTION OF THE PREFERRED EMBODIMENTS

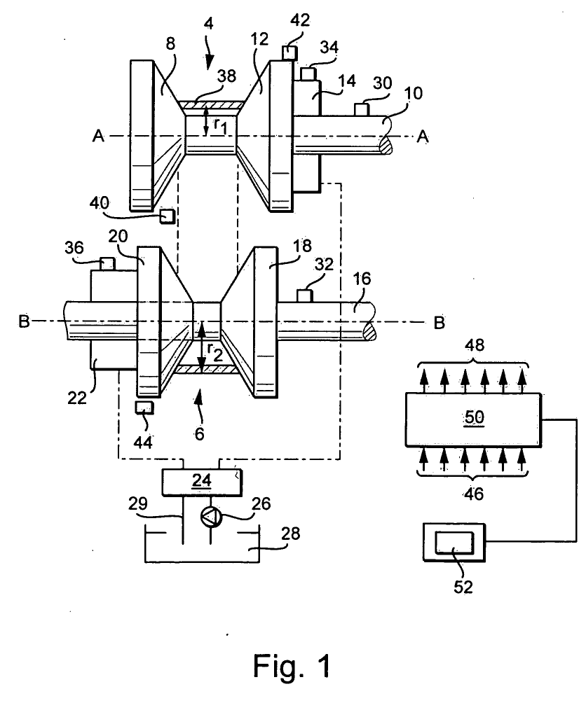

FIG. 1 shows a belt-driven conical-pulley transmission whose mechanical structure is known and that includes two conical disk pairs 4, 6 that are rotatable around respective axes A-A and B-B that are parallel to each other. Conical disk pair 4 includes a fixed disk 8 that is rigidly connected to a shaft 10, and an adjustable disk 12 that is connected to shaft 10 in a rotationally fixed manner and is movable axially relative to shaft 10 by means of a hydraulic unit 14.

In a similar way, but in the opposite orientation, conical disk pair 6 includes a fixed disk 18 that is rigidly connected to a shaft 16, and an adjustable disk 20 that is connected to the shaft 16 in a rotationally fixed manner and is movable axially relative to the shaft 16 by means of a hydraulic unit 22.

Hydraulic units 14 and 22 are supplied through a valve arrangement 24 with clamping pressure that is produced by a pump 26, that transports hydraulic fluid from a supply reservoir 28 into which a return line 29 issues.

The speeds of shafts 10 and 16 are detected by rotational speed sensors 30 and 32. The pressure prevailing in hydraulic units 14 and 22, with which the respective adjustable disk is pushed in the direction of the fixed disk, is detected by pressure sensors 34 and 36. The speed of an endless torque-transmitting means 38 that is in contact with the conical disks in a frictional engagement is detected by a speed sensor 40. The momentary positions of adjustable disks 12, 20 are detected by position sensors 42, 44.

The named sensors are connected to inputs 46 of a control and evaluation unit 50, whose outputs 48 serve to control valve arrangement 24, and possibly additional elements that are not shown, such as an automatic clutch, etc. Additional inputs to the control and evaluation unit are connected, for example, to an accelerator pedal sensor, a brake pedal sensor, and a gear selector unit of the vehicle, which are not shown.

The construction and function of an electronically controlled belt-driven conical-pulley transmission of the type described, including its control, are known and therefore will not be further explained.

A control and evaluation unit, which contains a microprocessor with associated storage devices, is also known in regard to its function as a control unit and therefore will also not be further explained.

The control and evaluation unit 50 in accordance with the invention, to which a display unit 52 is connected, contains additional sets of functions, implemented primarily by software, that will be explained below.

The loads on individual peripheral regions of the conical disks 8, 12 and 18, 20 of conical disk pairs 4 and 6 defined in terms of their radius r₁, or r₂, respectively, are applied as a function of the momentary clamping pressure between the end faces of the pins that pivotally interconnect individual links of the endless torque-transmitting means 38, and on the slippage or the relative speed between the end faces of the pins and the opposed regions of the conical disk surfaces. The greater the clamping pressure, and above all the greater the slippage at high clamping pressure, the more the end faces of the pins of the endless torque-transmitting means and the corresponding opposed surface regions of the conical surfaces of the conical disks will be damaged.

The clamping pressure between the pin end faces and the conical disk surfaces can be ascertained from the hydraulic pressure determined by sensors 34 and 36 and the geometry of the contact area of the end faces on the conical disk surfaces. The radius r₁, or r₂ of the peripheral segment of the conical disk surfaces then under pressure can also be ascertained from the distances between the conical disks of the respective conical disk pairs, which are determined by means of sensors 42 and 44. The slippage between the endless torque-transmitting means 38 and the respective conical disk pair can be ascertained from the rotational speeds determined by sensors 30 and 32, and the speed of the endless torque-transmitting means determined by sensor 40.

The damage S_{B} to the faces of the pins of endless torque-transmitting means 38 is given for example by the general formula:
S_{B}=f_{B}(p, s, t),
where p is the clamping pressure, s is the current slippage, and t is the length of time during which the particular clamping pressure p and the particular slippage s are present.

The damage S_{Sr} to a particular peripheral element with radius r of a conical disk surface is given, for example, by:
S_{Sr}=f_{S}(p, s, t),
where the functional correlation f_{S} is different from the functional correlation f_{B} due to the different material volumes and materials in general.

The functional correlations f_{B} and f_{S} are generally not linear. The damage increases exponentially in general as the product of p and s increases. The instances of damage that occur during a particular time period are cumulative, so that the functions contain integrals.

The functional correlations f_{B} and f_{S} can be derived by functional analysis, or they can be determined on the basis of test stand trials. It is also possible to use both methods, by parameterizing and verifying an analytically derived algorithm by means of test stand trials.

The functions f_{B} and f_{S} are stored in control and evaluation unit 50, so that the particular damage value S that is reached during operation of the transmission can be calculated in control and evaluation unit 50. When the transmission is taken out of operation, the momentarily reached damage value is stored in a non-volatile memory, so that it is available as the starting value at the next start-up. Also stored in control and evaluation unit 50 are critical damage values, such that if they are reached, display unit 52, for example, is activated and emits a warning.

The then-existing damage value, reached after a number of operating cycles, can be extrapolated under the assumption that a similar mode of operation will continue, so that a remaining service life until critical damage values are reached can be predicted, and possibly displayed.

If especially high damage values are reached in individual radial peripheral regions of the disk surfaces, the transmission or its transmission ratio can be controlled in such a way that the radial regions of the conical disk surfaces with high damage are no longer used, or are only used a little, so that maximum uniformity of damage is attained, and thereby long service life.

The described functions f_{B} and f_{S} can contain the temperature T instead of p and s at the point of the frictional engagement; it can be calculated, for example, from p and s or measured directly. Furthermore, the speed of the particular shaft can be included in the function as an additional operating parameter.

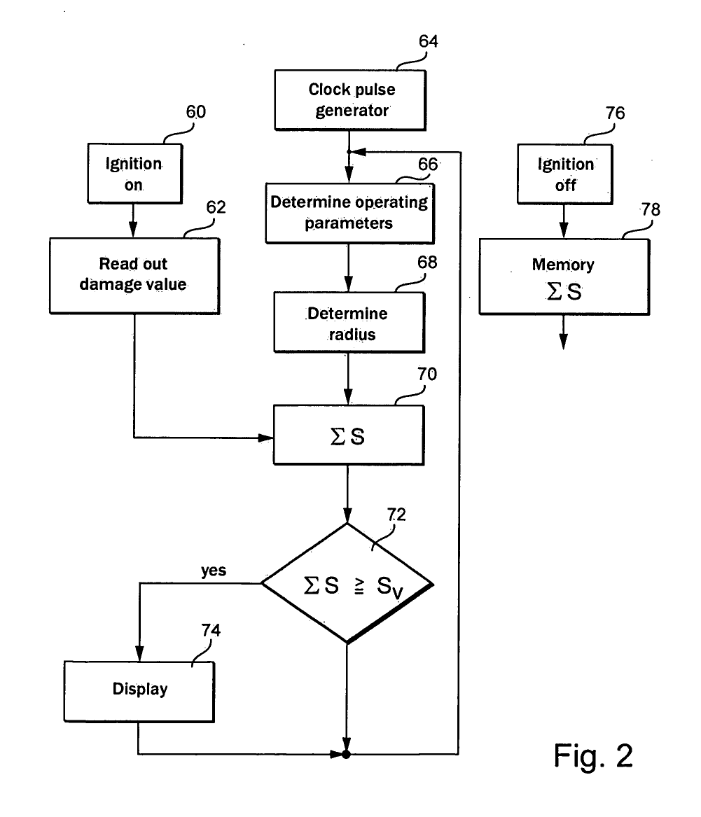

A flow chart of a method in accordance with the invention will now be explained on the basis of FIG. 2.

If the ignition of the vehicle is switched on or the vehicle is started up, for example, in a step 60, in step 62 the individual damage values are read from a non-volatile memory (e.g., from ROM or an EEPROM). In step 64 a clock pulse generator is activated, which controls the determination of the damage-relevant operating parameters in step 66 and the determination of the respective radii of the ring-like regions of the conical surfaces that are frictionally engaged by the pins of the endless torque-transmitting means for sequential time units. From the values determined in steps 66 and 68, the additional increment of damage that occurred during the time unit is calculated on the basis of the damage model, and in step 70 it is added to the momentary total damage value present at the end of the previous time unit, where the total damage value at the start of clock pulse generator 64 corresponds to the damage value read out in step 62. In step 72 the cumulative damage value ΣS ascertained in step 70 is compared to a predefined critical damage value S_{V}. If the critical damage value has been reached, in step 74 a display is activated that indicates that critical damage has been reached. While taking account of the critical damage that can result, for example, in a change in the control of the transmission so that frictional engagement is avoided as much as possible at places where critical damage has been reached, the system continues to run, just as it does in the event that it is found in step 72 that the critical damage value has not or has never yet been reached.

If the ignition is switched off in step 76, the total damage value ascertained in step 70 is stored in non-volatile memory in step 78, so that it can be read in step 62 of a subsequent operating cycle.

It is understood that the cumulative damage value ΣS advantageously stands in each case for a multitude of total damage values that correspond to the damage to the end faces of the pins of the endless torque-transmitting means and to the damage to the individual ring-like surface regions of the conical surfaces of the conical disks, which are a function of the radius.

Although particular embodiments of the present invention have been illustrated and described, it will be apparent to those skilled in the art that various changes and modifications can be made without departing from the spirit of the present invention. It is therefore intended to encompass within the appended claims all such changes and modifications that fall within the scope of the present invention.

What is claimed is:

1. A method for monitoring the operational reliability of a transmission having a continuously variable transmission ratio and that transmits torque by frictional engagement of components, said method comprising the steps of:
providing a damage model that includes a damage value that is a function of operating parameters applicable to an assessment of damage to contact regions that transmit torque by frictional engagement;
ascertaining the values of the operating parameters during operation of the transmission;
determining a measured damage value from the ascertained values of the operating parameters; and
displaying a value derived from a momentary measured damage value.

2. A method in accordance with claim 1, including the steps of: storing a damage value determined at an end of an operating cycle; and providing the stored damage value as a starting damage value at the beginning of a subsequent operating cycle.

3. A method in accordance with claim 1, including the step of sensing at least one of the following operating parameters during operation of the transmission: temperature at a frictional contact region; pressure between frictionally engaged transmission components; slippage between frictionally engaged transmission components; and location of frictional engagement between frictionally engaged components; and duration of frictional engagement.

4. A method in accordance with claim 1, wherein the transmission having a continuously variable transmission ratio that transmits torque by frictional engagement of transmission components is a belt-driven conical-pulley transmission.

5. A method in accordance with claim 1, including the step of controlling the transmission so that frictional engagement between contact regions having high damage values is avoided.

6. Apparatus for monitoring the operational reliability of a transmission having a continuously variable transmission ratio that transmits torque by frictional engagement of transmission components, said monitoring apparatus comprising: sensors for detecting operating parameters that are relevant for assessing damage to contact regions of the transmission that transmit torque by frictional engagement of transmission components; an evaluation unit connected to the sensors for determining a damage value from sensed values of the operating parameters on the basis of a damage model stored in the evaluation unit; a storage device in which damage values determined during an operating cycle are stored so that they are available as a starting value for a subsequent operating cycle; and a display device for displaying a value derived from a momentary damage value.
